(19) United States
(12) Patent Application Publication
(10) Pub. No.: US 2005/0145576 A1
(43) Pub. Date: Jul. 7, 2005

(54) Removal of particulate contamination from operating machinery

(76) Inventor: Gerald L. Munson, Madison, CT (US)

Correspondence Address: JOHN H CROZIER, 1934 HUNTINGTON TURNPIKE, TRUMBULL, CT, 06611, US

(21) Appl. No.: 10/515,865

(22) PCT Filed: May 28, 2003
(86) PCT No.: PCT/US03/16768

(30) Foreign Application Priority Data
May 28, 2002 (US) 60383551

(51) Int. Cl. C02F 1/46

(52) U.S. Cl. 210/748; 210/702; 210/806

(57) ABSTRACT

A method and system for removing particulate contamination from operating machinery comprise balanced charge agglomeration to eliminate or reduce electro potential between particulate contamination in a fluid circulating in operating machinery.

### TECHNICAL FIELD

The present invention relates to particulate removal generally and, more particularly, but not by way of limitation, to novel means and method for removing particulate contamination from operating machinery.

### BACKGROUND ART

Operating machinery use insulating liquids to carry heat to points of dissipation, reduce friction, and transfer forces hydraulically. These insulating liquids include lubricating oils, hydraulic liquids, and fuels used in machinery, or stored for future use, and contain and convey particulate contamination to remote locations of these physical systems, including storage tanks. These particulates are introduced during manufacture, transport, delivery, storage, and use of the liquid. These contaminants are detrimental in several ways.
1. They accumulate throughout the mechanical system.
2. They provide surface area for the accumulation of water.
3. They provide the sites for accumulation of unbalanced electrostatic charges.
4. They provide, in combination with the water, incubation sites for bacteria.
5. They provide the materials for chemical processes that accelerate the oxidation of the liquid.
6. These tenuous collections of particles can under thermal or mechanical shock move back into the liquid presenting sudden massive onset of mechanical wear in rotating or translating machinery, resulting in catastrophic failure
7. They can constitute, after chemical reaction, monomers which when presented with a thermal gradient at the boundary of the liquid containment system, accumulate and polymerize into substances commonly known as “varnishes”. These varnishes are mechanically substantial and have high thermal impedance, relative to the insulating liquid.
8. The circulation of these particulates, when coming in contact with the extremes of the containment system, and having sufficient velocity, will achieve an electric charge in accordance with the differential material of the particulate and the containment, and proportional to the velocity. Insofar as the liquid in the vicinity of the particulate is an insulator, the charge will tend to remain on the particle, within the constraints established by Millikin and others.
9. These charges in combination with water at the oil particulate interface can give rise to electrochemical reactions that in the case of contaminant particulate can be both unintended and detrimental.

These particles remain in solution as colloidal suspensions until acted upon by the forces of coagulation, flocculation, or agglomeration to produce masses of particles that accumulate in an uncontrolled fashion in quiet eddies or narrow passages that are subject to limited flow. Many of these liquids are hydrophilic, absorbing water from their surroundings. This water in combination with the particulate contamination causes accelerated oxidation, acidification, and chemical degradation of the liquid properties.

Furthermore, the removal of these particulates from an operating system eliminates the mechanism for accelerated mechanical wear. In addition, the removal of these particulate contaminants, and the water associated with those particulates, precludes the deposit of hydrolyzed coatings at the interface of the liquid containment system, thereby maximizing thermal conductivity.

Also, the transport of the water associated with the particulate removed from the liquid eliminates the potential sites for the gestation of bacteriological reproduction. Elimination of these contaminants from the liquid environment precludes the above unintended and therefore detrimental chemical and mechanical consequences of this contamination.

### DISCLOSURE OF INVENTION

The present invention achieves the above objects, among others, by providing, in one preferred embodiment, a method of removing particulate contamination from operating machinery, comprising: using balanced charge agglomeration to eliminate or reduce electro potential between said particulate contamination in a fluid circulating in said operating machinery and fluid containment. In another preferred embodiment, apparatus for removing particulate contamination from operating machinery is provided.

### BRIEF DESCRIPTION OF DRAWINGS

Understanding of the present invention and the various aspects thereof will be facilitated by reference to the accompanying drawing figures, submitted for purposes of illustration only and not intended to define the scope of the invention, on which:

FIG. 1 is schematically illustrates a machine with which the present invention may be used.

FIG. 2 is a flow diagram of the process of the present invention.

FIGS. 3(A) and 3(B) schematically illustrate a galvanic sensor according to the present invention.

FIGS. 4(A) and 4(B) schematically illustrate a particulate charge sensor according to the present invention.

FIGS. 5-8 schematically illustrate various pre-treatment options according to the present invention.

FIGS. 9-12 schematically illustrate various chemical treatment options according to the present invention.

FIGS. 13(A) and 13(B) schematically illustrate a charging/mixing chamber according to the present invention.

FIG. 14 schematically illustrates a solids extractor according to the present invention.

FIG. 15(A) schematically illustrates a collection chamber according to the present invention.

FIG. 15(B) gives the effect of increasing solids content.

### BEST MODE FOR CARRYING OUT THE INVENTION

The purification system detailed herein is intended for, by is not limited to, removing particulate contamination from a remote system which may or may not be an operating machine. The removal of physical contamination from the fluid is a necessary component of his systemic cleansing. The current invention may also be used to remove certain chemical contamination to facilitate the particulate removal from the machine.

During the normal circulation of liquids due to thermal or forced circulation, electric charges are transferred to, or induced upon a portion of solid particulate contamination that always exist in liquids. These electrically charged particles have one charge polarity for material of like composition. If one type or class of material shall predominate as a contaminant within the liquid, the contaminants will take on a unipolar electrical charge. At a point where this charge creates an imbalance of more than 30 Millivolts with regard to an earth ground, the contaminants will constitute a stable colloidal suspension. The movement of these colloids can constitute an electrical current as much as anions and cations in an electrolyte. In this fashion, they can be responsible for the electrodepositing of a range of contaminant material on conductive surfaces. These electrically charged particles cause detrimental effects, as noted above.

These particles, electrically charged and aquatically saturated, settle throughout the containment environment and constitute electrochemical retorts, which create accelerated chemical and electrochemical reactions.

The nature of these particles is generally such that if these contaminants are sufficiently removed from other macro and micro mechanical components, an electric charge can be stored on the particle at the liquid mechanical interface of the particle. If these charges are unipolar, they will cause a repulsive force in accordance with coulombs law. This force will tend to disperse these like charged particles.

If two isolated conduits of liquid are created, each creating a unipolar stream of charged particles, and yet the two streams are of opposite polarity, these oppositely charged particles can be used to collect both charged and uncharged particles from the storage reservoir and the other environs where the liquid may pass.

The process described herein removes those contaminant particulates from the machine and/or storage tank to a central removal point, and in so doing precludes the accelerated decay of the original liquid properties. The removal and elimination of these particles from the machine/containment environment is critical to promoting the greatest longevity of the liquid/machine/containment system.

Specifically, through use of controlled currents injected onto the particulate contamination in a recirculating liquid, the average electrostatic charge on the particulate is forced to zero. Then over time, the absolute electric charge at any point in the liquid is reduced to zero. This process of eliminating the electric unbalanced charge on all of the particulate within the system creates an environment where the maintenance of a colloidal suspension is impossible. This is desirable because this promotes coagulation and agglomeration at the point of neutralization. Within this process, the point of neutralization is within the liquid at the point of interaction between particulate streams of equal and opposite charge.

The polarity of the electrical charges created on the surface of the contaminant particulate is dictated by the nature of the particulate and the containment and the liquid. The magnitude of the charge is proportional to the differential velocities. Since the materials of construction of most containments are of uniform material, and the particulate contamination will usually be predominantly one material, the polarity of the transferred charge will be unipolar in nature.

The invention causes liquid to flow into an isolated system. The invention splits the moving liquid into two streams. The invention creates a higher population of charged particulate than the population normally existing in the liquid, on a volumetric basis, through the use of high voltages and charge transfer electrodes. The charge transferred to the particles is distributed to two isolated electrodes. The charges to the two electrodes are of opposite polarity. The invention controls the electric currents being transferred onto the particles such that the currents are initially nearly identical. The two charged liquid streams are then mixed to cause the particulate contamination to agglomerate to a larger size.

The mixed charged streams are passed through an electrically isolated particulate removal subsystem, removing some of the contaminants. The subsystem is constructed of partially conductive equipment suitable for removing particles from the subject stream. The incident stream of liquid and particles will impact the partially conductive equipment, removing particles larger than the specific size. The conductive nature of the subsystem will transfer the aggregate charge contained on the particles to the control input. The feedback connection from the subsystem to the control will transfer any unbalanced charge to the control to maintain the voltage on the system at zero.

The particles that are too small to be removed by the system, flowing from the subsystem, will have the same average electrical charge polarity as the subsystem.

The liquid and the particulate are recirculated multiple times within the subsystem before exiting the subsystem through the final “collection filter”. This iterative process exposes the contaminants to more than 20 times as many trips through the charging mixing equalizing purification scheme than a once through execution could achieve. The result of this process is the control of contamination at the part per billion level.

The increased efficacy and speed of operation of this execution provide superior benefits. The reduction and elimination of particulate contamination from liquid streams through the loop within system concept can provide more than four orders of magnitude reduction in contamination than with a single traverse of the system. Controlling the net electrical charge on both the inner and the outer loop at zero provides accelerated performance in both domains.

Reference should now be made to the drawing figures on which similar or identical elements are given consistent identifying numerals throughout the various figures thereof, and on which parenthetical references to figure numbers, when used, direct the reader to the figure(s) on which the element(s) being described is (are) most clearly seen, although that (those) element(s) may be shown on other drawing figures also.

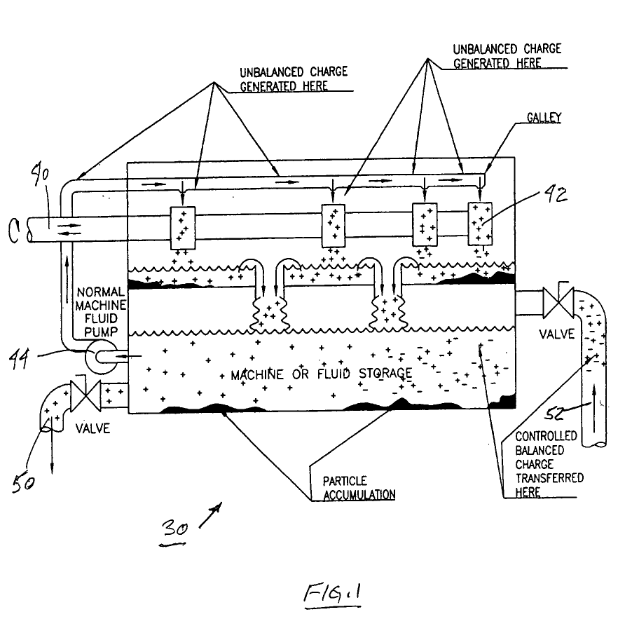

FIG. 1 illustrates typical machinery, generally indicated by the reference numeral 30, that may be served by the present invention. Machinery includes a rotating shaft 40 held in place by a plurality of bearings as at 42 and lubricated by a liquid circulated by a pump 44. The lubricating liquid is accumulated in the base of machinery 30 or in a separate fluid storage vessel. It will be understood that machinery 30 may take various forms and that shown is for illustrative purposes only. An outlet 50 conveys lubricating liquid to the system of the present invention and a return 52 conveys lubrication liquid from the system of the present invention. Bearings 42 are shown as providing a positive charge, but the charge could be predominantly negative as well.

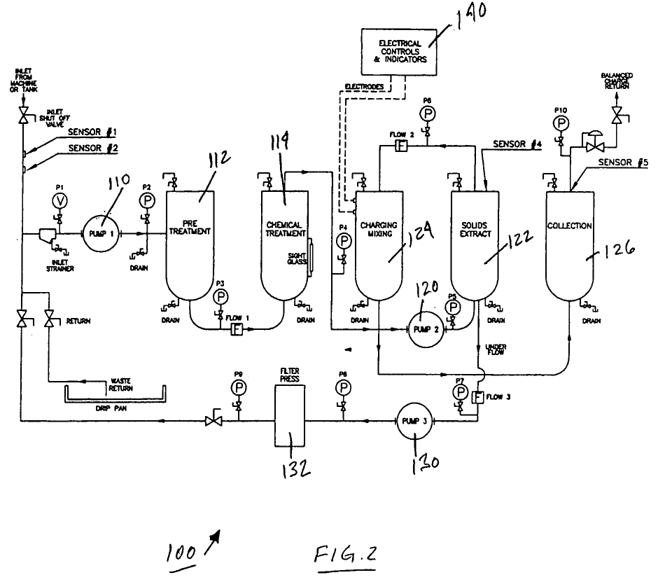

FIG. 2 is a flow diagram of the system of the present invention, generally indicated by the reference numeral 100, and it should be noted that “FLOW 2” is greater than or equal to “FLOW 1” which is much greater than “FLOW 3”. System 100 includes as major elements at the front end thereof a first pump 110 that conveys lubricating liquid from machinery 30 (FIG. 1), a pre-treatment stage 112, and a chemical treatment stage 114. A second pump 120 circulates liquid between a solids extract stage 122 and a charging/mixing stage 124. Relatively clean liquid flows from charging/mixing stage 124 to a collection stage 126 that removes any fine particulate material and then returns to machinery 30 (FIG. 1). Agglomerated particulate flows from solids extract stage 122 through a third pump 130 and through a filter press 132 where the agglomerated particulate is removed. SENSORS #1-#5 provide inputs to a electrical controller 140, the electrical controller providing outputs to electrodes in charging/mixing stage 124. Elements not specifically discussed with reference to FIG. 2 are shown in their conventional symbols.

FIGS. 3(A) and 3(B) schematically illustrate SENSOR #1 (FIG. 2), generally indicated by the reference numeral 150, which measures the galvanic potential between an electrode 152 and the liquid containment.

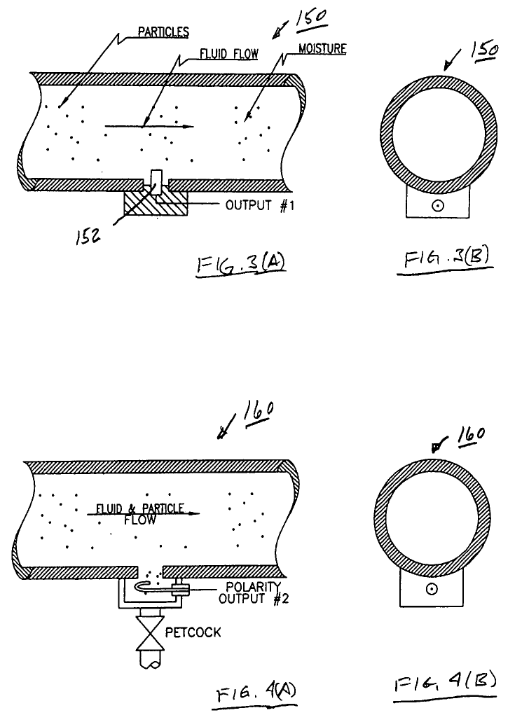

FIGS. 4(A) and 4(B) schematically illustrate SENSOR #2 (FIG. 2), generally indicated by the reference numeral 160, which measures the electrical potential carried on the surface of the particulate in the liquid stream.

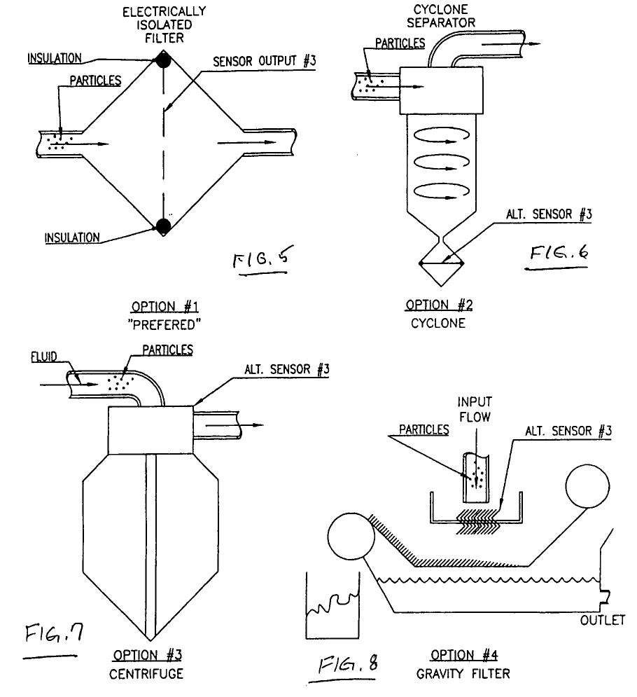

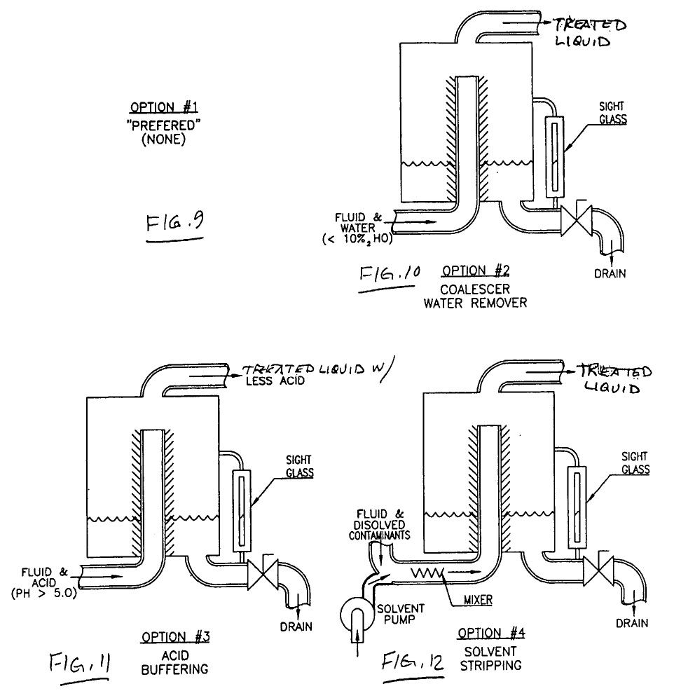

FIGS. 5-8 schematically illustrate various options for pretreatment stage 112 (FIG. 2), delineated for the removal of excess large particulate matter entering system 100. The liquid flow leaving pre-treatment stage 112 preferably reduces contaminant level to concentrations of about less than 0.1 percent by volume. The option shown on FIG. 5 is the preferred option.

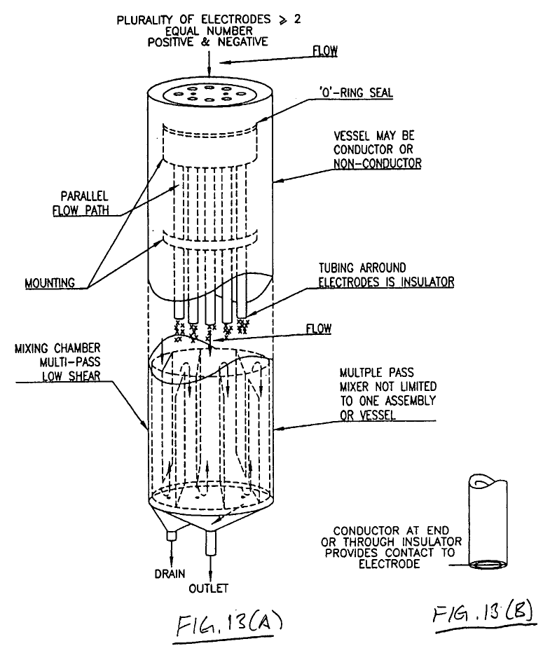

FIGS. 9-12 schematically illustrate various options for chemical treatment stage 114 (FIG. 2), delineated for the removal of undesirable chemical components that may be present in the liquid stream. The preferred option is “NONE” illustrated schematically on FIG. 9, it being desirable that no undesirable chemicals be present in the liquid stream.

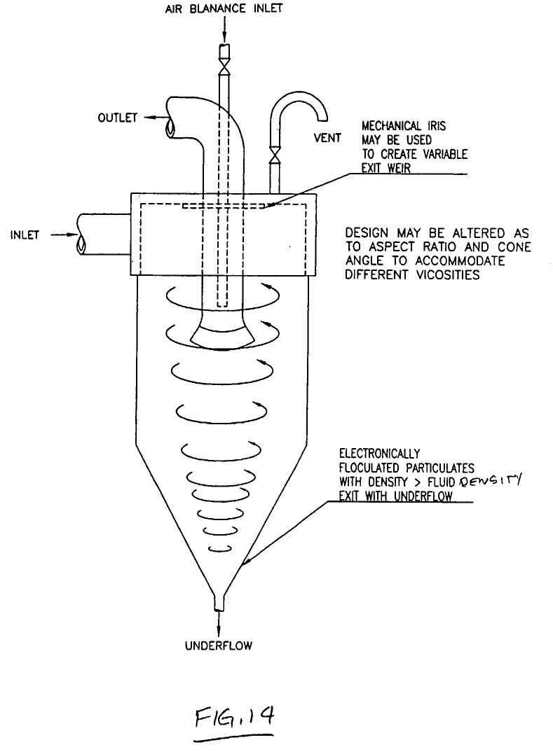

FIGS. 13(A) and (B) schematically illustrate charging/mixing stage 124 (FIG. 2). The charge placed on the electrodes is preferably less than about +/−30 kV.

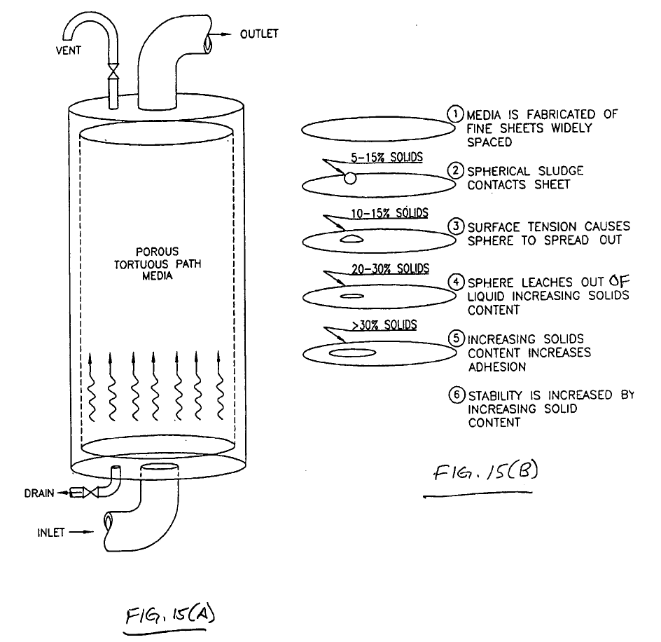

FIG. 14 schematically details specific variations of a standard hydro clone used for concentrating the agglomerated masses, thus facilitating their removal. The air balance is used to maintain a cone of air in the center of the hydro clone to prevent vacuum formation at the underflow thereof.

FIG. 15 schematically illustrates the construction and methodology of capturing, stabilizing, and retaining the solids which are agglomerated from within the liquid.

The use of balanced charge agglomeration has the following beneficial effects:
1. Eliminates or reduces the electro potential between the particulate contamination in the fluid and the fluid containment, thereby eliminating the force that removes charged particulate contamination from the fluid causing accumulation within the machine.
2. With the associated reduction in fine particulate within the recirculating fluid, eliminates or reduces the surface area for the collection and storage of water within the hydrophilic liquid. Eliminating this water from the fluid:
(a) decouples the electrochemical cell that is the precursor for corrosion,
(b) eliminates a necessary component for sludge,
(c) eliminates a component for hydrolytic chemical reactions, and
(d) eliminates a component for the accumulation of ionic reactive components within the liquid.
3. With the associated reduction in fine particulate within the recirculating fluid, eliminates or reduces the surface area for the collection and storage of gasses within the liquid. These gasses:
(a) accelerate the oxidation and nitration of the liquid,
(b) alter the wetting characteristics of the liquid,
(c) reduce the thermal capacity of the fluid, and
(d) alter the viscosity relationship with pressure, which will normally have a positive first derivative.
4. With the associated reduction in fine particulate within the recirculating fluid, increases the surface tension of the liquid.
5. With the associated reduction in fine particulate within the recirculating fluid, increases the solvency of the fluid for those components which have been removed from the liquid. For example, for any contaminant and any condensate of that contaminant at the confinement of the fluid, there will be a solubility product constant which defines the ratio of material in solution, and material not in solution at a given temperature. By removing these contaminants with the present invention, there is automatic promotion of the dissolving of those components that have accumulated at the margins of the liquid confinement, through the action of the solubility product constant.
6. With the removal of fine solid contamination both less than and greater than one micrometer in diameter, there is an increase in the apparent vapor pressure of both liquid and gaseous contaminants within the liquid, causing the escape of these components into the headspace above the reservoir for the fluid, therefore establishing a contaminant level within the fluid after removal of these particulate contaminants, which will be ½ to 1/10 of the previous and historical levers for these liquids and gasses.
7. The elimination or reduction of the solid, liquid, and gaseous contaminants as above reduces both abrasive and erosive wear by a minimum factor of ten times.
8. The elimination or reduction of the contaminants, as noted above, enhances the intended actions of additive formulated with these liquids for the purpose of:
(a) bonding with wear surfaces to enhance wear characteristics,
(b) bonding with oxygen molecules preferentially to reduce oxidation of the native liquid,
(c) improving liquid water interfacial tension, and
(d) reducing nitration or dissolved nitrous oxides.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “outer”, “inwardly”, “vertical”, “horizontal”, and the like, where used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention that, as a matter of language, might be said to fall therebetween.

1. A method of removing particulate contamination from operating machinery, comprising: using balanced charge agglomeration to eliminate or reduce electro potential between said particulate contamination in a fluid circulating in said operating machinery and fluid containment.

2. A method of removing particulate contamination from operating machinery, as defined in claim 1, further comprising: using said balanced charge agglomeration to remove or reduce fine particulate from said fluid circulating in said operating machinery.

3. A system for removing particulate contamination from operating machinery, comprising: balanced charge agglomeration apparatus to eliminate or reduce electro potential between said particulate contamination in a fluid circulating in said operating machinery and fluid containment.

4. A system for removing particulate contamination from operating machinery, as defined in claim 3, further comprising: apparatus to remove or reduce fine particulate from said fluid circulating in said operating machinery.
